(19) United States
(12) Patent Application Publication
(10) Pub. No.: US 2024/0121107 A1
(43) Pub. Date: Apr. 11, 2024

(54) Identification Of A Suspect Computer Application Instance Based On Rolling Baseline

(71) Applicant: Flying Cloud Technologies, Inc., Polson, MT (US)

(72) Inventor: Brian P. Christian, Sioux Falls, SD (US)

(21) Appl. No.: 18/214,628

(22) Filed: Jun. 27, 2023

Related U.S. Application Data
(63) Continuation-in-part of application No. 17/880,898, filed on Aug. 4, 2022.
Application No. 17/880,898 is a continuation-in-part of application No. 17/154,915, filed on Jan. 21, 2021, now Pat. No. 11,445,340.

(51) Int. Cl. H04L 9/32; H04L 9/00; H04L 9/40

(52) U.S. Cl. CPC H04L 9/3247; H04L 9/3239; H04L 9/50; H04L 63/1425

(57) ABSTRACT

Techniques are disclosed for analyzing data related to computer applications and identifying suspect instances of such applications based on rolling baseline. The analysis is performed by a baseline engine that first establishes a rolling baseline with a centroid of a conceptual hypercube. The centroid represents the normal population of data packets for a given type of computer application. Data packets far enough away from the centroid indicate an anomaly or a suspect event for that computer application. An early detection of such suspect events and suspect application instances can prevent catastrophic downstream consequences for the concerned party/parties. Related embodiments also record suspect events and the identity of the suspect applications in a private and/or public distributed ledger, including a blockchain.

### RELATED APPLICATIONS

This application is a continuation-in-part (CIP) of U.S. patent application Ser. No. 17/880,898 filed on Aug. 4, 2022, which is a continuation-in-part (CIP) of U.S. Pat. No. 11,445,340 issued on Sep. 13, 2022.

This application is also related to U.S. patent application Ser. No. 16/219,931, now U.S. Pat. No. 10,516,689 B2 issued on Dec. 24, 2019. This application is also related to U.S. patent application Ser. No. 16/058,145, issued on Dec. 31, 2019. This application is further related to U.S. patent application Ser. No. 16/120,704, now U.S. Pat. No. 10,542,026 B2 issued on Jan. 21 2020. This application is also related to U.S. patent application Ser. No. 16/700,554, now U.S. Pat. No. 10,848,514 B2 issued on Nov. 24, 2020. This application is also related to U.S. patent application Ser. No. 16/804,351, now U.S. Pat. No. 10,887,330 B2 issued on Jan. 5, 2021. All the above numbered U.S. Patent Applications and U.S. Patents are incorporated by reference herein for all purposes in their entireties.

### FIELD OF THE INVENTION

This invention relates to the field of data analyses for the purposes of identifying suspect or anomalous computer application instances.

### BACKGROUND ART

Surveillance of sites and properties for the purposes of proactively identifying threats and malicious actors is an active area of pursuit. The importance of early detection of security threats in the age of global pandemics and conflicts cannot be overstated. As a result, there is lot of active research on trying to identify computer/information security threats and anomalies on computer networks belonging to a variety of public and private organizations.

In as far as information security is concerned, U.S. Pat. No. 10,594,714 B2 to Crabtree describes a cybersecurity system that protects against cyberattacks by performing user and device behavioral analysis using an advanced cyber decision platform which creates a map of users and devices attached to a network. It then develops a baseline of expected interactions and behaviors for each user and device in the map, and monitors deviations from the expected interactions and behaviors.

U.S. Pat. No. 10,542,027 B2 to Wittenschlaeger discloses a hybrid-fabric apparatus that comprises a black box memory configured to store a plurality of behavior metrics and an anomaly agent coupled to the black box. The anomaly agent determines a baseline vector corresponding to nominal behavior of the fabric, wherein the baseline vector comprises at least two different behavior metrics that are correlated with each other. The anomaly agent disaggregates anomaly detection criteria into a plurality of anomaly criterion to be distributed among network nodes in the fabric.

U.S. Pat. No. 10,542,026 B2 to Christian teaches a data surveillance system for the detection of security issues, especially of the kind where privileged data may be stolen by steganographic, data manipulation or any form of exfiltration attempts. Such attempts may be made by rogue users or admins from the inside of a network, or from outside hackers who are able to intrude into the network and impersonate themselves as legitimate users. The system and methods use a triangulation process whereby analytical results pertaining to data protocol, user-behavior and packet content are combined to establish a baseline for the data. Subsequent incoming data is then scored and compared against the baseline to detect any security anomalies. A centroid representing the normal population of the data packets is identified. The design allows establishing the context of various events of interest in the organization, thus enabling dynamic management of security policies.

In the area of detecting the presence of humans or bodies in a network, U.S. Pat. No. 10,142,785 B2 to Wootton teaches systems and methods for detecting the presence of a body in a network without fiducial elements. It does so using signal absorption, and signal forward and reflected backscatter of radio frequency (RF) waves caused by the presence of a biological mass in a communications network.

In the area of surveillance monitoring, the product of iCetana™ proclaims a set of advanced, automated, video analysis tools that provide for the immediate detection and extraction of events and valuable data from surveillance footage. It is purported to increase the return on investment (ROI) of a surveillance system, and overall security, safety and business operations. The integration capabilities allow it operate on every camera connected to the surveillance system. The product claims to detect anomalies, enabling full event management through the client. This includes event notification with graphic overlay for both live and recorded (playback) video, simplified configuration, triggered recording, activation of outputs and more. Video search and business intelligence capabilities are embedded in the client, enabling retrieval of stored video and display of analytics results.

The product of FLIR® proclaims a desktop software offering an efficient, accurate way to perform elevated skin temperature screenings at ports of entry, checkpoints, building entrances, and other high-traffic areas. When connected to a thermal camera, the software activates as an individual enters the camera's field of view and provides guidance to correctly position them. The software places a hot spot on the individual's face and takes a skin temperature measurement within seconds. If the measured temperature exceeds a threshold set above the rolling baseline average, the system will notify the operator and present an alarm on the subject's viewing monitor. The individual can then be directed to a secondary screening with a medical device. This rapid, non-contact measurement system sets up in minutes, and helps organizations reduce the risk of work and production interruptions due to illness.

One of the shortcomings of the prior art teachings is that they fail to describe techniques that allow identification of suspect or anomalous computer application instances. Such technologies absent from the prevailing art would gather data from instances of various types of computer applications, analyze it by first establishing a rolling baseline respective to an application of a given type. Consequently, such a system absent in the prior art would then allow the identification of anomalous/suspect application instances at a site/environment.

### OBJECTS OF THE INVENTION

In view of the shortcomings and unfulfilled needs of the prior art, it is an object of the present invention to provide a set of techniques for identifying instances of suspect or anomalous computer applications and specifically their instances operating at a given site/environment.

It is also an object of the invention to accomplish the above by establishing a rolling baseline for such computer applications by clustering data packets and then scoring each incoming packet against a centroid of the rolling baseline.

It is also an object of the invention to identify the applications running on the network by their cryptographic signatures or hashes.

It is also an object of the invention to discover suspect application instances that are instances of legitimate applications but involved in some nefarious/undesirable activity.

It is also an object of the invention to discover suspect application instances that are malware but trying to masquerade or impersonate as a legitimate computer application by forging its signature.

It is also an object of the invention to discover suspect computer application instances of various types of applications including video-streaming applications, audio-streaming applications, social-networking applications, business applications, document management applications, artificial intelligence (AI) applications, computer-aided design (CAD) applications, graphics program applications, integrated development environment (IDE) or software development applications, data science graphing applications and computer games.

It is also an object of the invention to record the suspect event data which caused an application instance to be designated as a suspect instance, along with the identity of the instance in a blockchain ledger.

It is also an object of the invention to record the above identity and suspect event data in a partner system or another system/application.

These as well as other objects of the invention will be evident in the forthcoming summary and detailed description sections of this disclosure.

### SUMMARY OF THE INVENTION

The objects and advantages of the invention are secured by systems and methods for determining an identify of a suspect computer application, and specifically an instance of a suspect computer application. This is accomplished by first establishing a rolling baseline of various computer applications operating on a computer network at a given site or environment. The baseline is established by a rolling baseline engine taught in herein incorporated references cited above in the Related Applications section, including U.S. Pat. No. 10,542,026 issued on 21 Jan. 2020 to Christian.

The baseline engine assigns each incoming packet of data to a cluster of packets amongst clusters of packets of data. Preferably, the clustering is performed using k-means clustering. The baseline thus established is characterized by a conceptual hypercube with any number and types of dimensions on which the data is desired to be analyzed. The hypercube has a centroid that represents the “normal” population of packets.

Then, as subsequent packets arrive, they are scored against the baseline by computing their distance from the centroid of the hypercube. Any packets that are far away enough away from the centroid on a dimension of interest to be not normal are then designated as suspect or anomalous along with the suspect computer application instance that generated those data packets.

The identities of the computer applications generating the data are determined from their cryptographic signature or fingerprint, such as a JA3 hash. In this manner, suspect computer application identification system of the present design is able to analyze data from a variety of different computer applications. It is able to identify them and designate those instances of these applications that to not appear normal as suspect or anomalous.

In a preferred embodiment, the suspect computer application instance masquerades/impersonates as a legitimate computer application by forging the signature of the legitimate computer application. In various preferred embodiments, the suspect computer application instance may be a video-streaming application, an audio-streaming application, a social-networking application, a business application, a document management application, an artificial intelligence (AI) application including a generative AI application, a computer-aided design (CAD) application, a graphics program or graphics editor applications, an integrated development environment (IDE) or software development application, a data science graphing application and a computer game or a computer gaming application. In still other or related embodiments, the suspect computer application instance is simply an outdated version of a legitimate computer application.

In practical terms, the suspect computer application instance may be any computer (software or hardware) application instance or malware operating on the computer network. The anomaly or suspect event that causes an application instance to be designated as suspect/anomalous corresponds to the underlying data packet(s) to be far enough away from the centroid of the baseline per above. The data associated with such a suspect event is thus referred to as suspect event data and is evidently related to the suspect computer application instance. Such a suspect instance belongs to an application of a given type or identity. Therefore, it is possible to have both normal and suspect instances of a given computer application operating on the network.

A set of highly preferred embodiments record the identification of a suspect application instance in a distributed ledger. In these embodiments, each block entered into the distributed ledger is identified by a unique hash. The unique hash is preferably derived from a number of data fields/attributes, including but not limited to a date and time at which suspect event data was generated, the cryptographic hash or signature identifying the suspect computer application, and a portion or all of a payload of the suspect event data.

Any number of desired attributes related to the suspect event may also be recorded in the block of the distributed ledger. These data attributes include but are not limited to a username for a user of the suspect computer application, a username for the user who generated the data, a username for the user who transmitted the data, a name of a network protocol used in a transmission of the data, a device name, an IP address, a machine name, a MAC address, a NIC address, a port number on which the transmission was made, among others.

In the same or related embodiments, the present technology also generates various insights about the suspect computer application instance that it identifies. These insights include but are not limited to predicting patterns of failure of various computer applications, predicting patterns of threats, their severity and timings, as well as identifying certain types or categories of applications, devices and users that are prone to or associated with security incidents.

Such insights also include associating certain types of suspect events or threats with specific types of computer applications. For example, a certain video streaming application may be more vulnerable to data exfiltration threats/events, a certain social-networking application may be most associated with phishing events, etc.

In related embodiments, the distributed ledger in which the identification of the suspect computer application and suspect event data is recorded, is a private distributed ledger e.g. a private or internal blockchain ledger. In a preferred variation, the private blockchain ledger links to another computer system or application by utilizing a ledger reference data field. The system/application may be a partner or external system or application such as a vector or relational database or a general ledger.

In the same or related variation, the private blockchain ledger links to a public blockchain ledger via a supplemental hash. The supplemental hash is preferably derived from the unique hash of the block in the private ledger and a token of the public ledger. Such a public ledger may be a Bitcoin blockchain, an Ethereum blockchain and a Dogecoin blockchain.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a conceptual diagram illustrating the suspect computer application identification system of the present design.

FIG. 2 is a detailed diagram illustrating various instances of computer applications as well as suspect instances identified based on the present technology.

FIG. 3 shows embodiments of the present technology where the identified suspect instances and events and any associated data is recorded in a distributed ledger.

FIG. 4 is a variation of FIG. 3 where the distributed ledger is an internal or private blockchain ledger.

FIG. 5 is a variation of FIG. 4 where the private blockchain ledger is linked to a public blockchain ledger such as Bitcoin, Ethereum, Dogecoin, and the like.

FIG. 6 is a variation of FIG. 5 where the private distributed ledger is also linked to other computer applications and systems.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

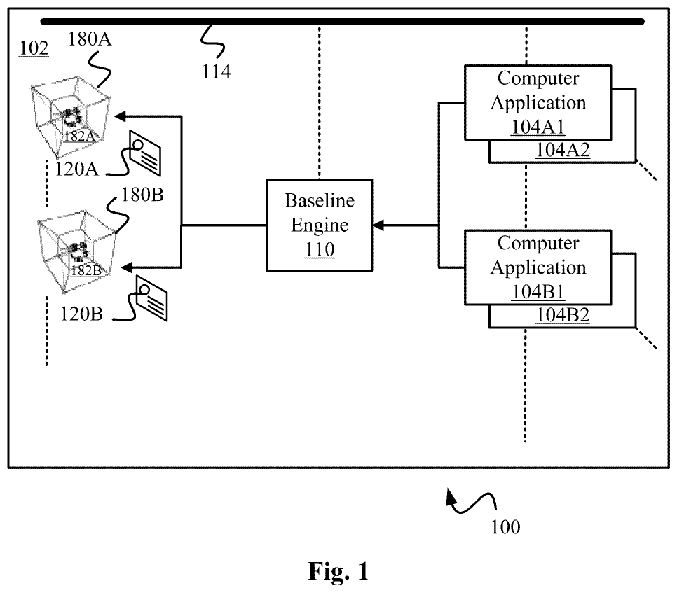

The techniques described herein may employ computer code that may be implemented purely in software, hardware, firmware or a combination thereof as required for a given implementation. The system and methods of the present technology will be best understood by first reviewing a suspect computer application identification system 100 as illustrated in FIG. 1. Suspect computer application identification system 100 of FIG. 1 is a type of a data surveillance system. Fig. shows system 100 comprising a baseline engine 110 connected via a communication network 114 to a number of computer application instances 104A1, 104A2, . . . 104B1, 104B2, . . . at a site or an organization or an establishment or facility or property or environment 102.

Baseline engine 110 shown in FIG. 1 and used by the present technology is the rolling baseline data surveillance system taught in detail in above-incorporated references including U.S. Pat. No. 10,542,026 issued on 21 Jan. 2020 to Christian. Per above teachings, baseline engine 110 analyzes data packets on network 114 generated or originated by various computer applications or simply applications 104.

For each different type of application such as 104A, 104B, . . . baseline engine 110 generates a respective baseline 120A, 120B, . . . . Each such baseline 120A, 120B, . . . has a respective hypercube 180A, 180B, . . . with a respective centroid 182A, 182B, . . . representative of the normal population of data packets for the corresponding computer application type 104A, 104B, . . . .

Explained further, baseline engine 110 analyzes each packet of data generated by applications 104A, 104B, . . . . Computer application 104A may be a video streaming application such as Youtube. Various instances of computer application 104A are denoted by 104A1, 104A2, and so on. Similarly, reference numerals 104B1, 104B2 and so on denote various instances of another type of computer application 104B, such as a social-networking application e.g. Facebook®, LinkedIn®, among others. Any number and types of such computer applications 104 may be present.

Computer applications 104 include but not limited to business applications e.g. Oracle®, Netsuite®, Quickbooks®, document management systems/applications, artificial intelligence (AI) applications including generative AI applications e.g. ChatGPT, computer-aided design (CAD) applications e.g. AutoCAD®, Vectorworks®, mathematical software such as MATLAB®, Mathematica®, graphics program applications including graphics edit applications e.g. Adobe Photoshop®, Adobe Illustrator®, integrated development environment (IDE) or software development applications e.g. Visual Basic® or Visual C++® IDE or a JAVA™ IDE, data science graphing applications e.g. Tableau®, Neo4j®, and computer games.

As a part of its analysis, baseline engine 110 assigns each packet of data gathered from computer network 114 and in turn generated by or related to computer applications 104, to a cluster of packets amongst clusters of packets of data. The clustering is done preferably by utilizing k-means clustering, specifically by utilizing Eq. (1) of the above-incorporated references and teachings. As a result, baseline engine 110 establishes a rolling or evolving baselines 120A, 120B and so respectively for various types of computer applications 104A, 104B and so on. These baselines signify the mean or normal behavior of the packets of respective computer applications 104.

Baselines 120A, 120B, . . . are based on respective conceptual hypercubes 180A, 180B, . . . with respective centroids 182A, 182B, . . . as shown in FIG. 1 representing the “normal” populations of data packets related to corresponding applications 104A, 104B, . . . . For brevity, we may just refer to centroids 182A, 182B, . . . of respective hypercubes 180A, 180B, . . . of baselines 120A, 120B, . . . of computer applications 104A, 104B, . . . in the singular form as centroid 182A of hypercube 180A of baseline 120A of computer application 104A, knowing that the same nomenclature extends to application 104B, 104C and so on.

As data packets from respective applications 104 arrive via communication network 114 at baseline engine 110, it scores each packet based on its distances from its respective centroid 182 of baseline 120. More specifically, it first identifies which application type or group each data packet belongs to e.g. 104C. It then scores that packet against the appropriate baseline e.g. 120C. It does this identification of the data packet by analyzing a signature or fingerprint contained in the data packet.

For example, if baseline engine 110 receives a data packet that has a signature of a particular social-networking application such as Skype™, it will then score that packet against the appropriate baseline/centroid for Skype, e.g. 120C/182C. Since baseline 120C with centroid 182C signifies the “normal” behavior of packets for Skype, packets that are far away from centroid 182C represent an anomaly or a suspect event. The data packets themselves causing the suspect event constitute suspect event data. Thus, a given instance 104C3 of computer applications Skype 104C on network 114 may be involved in an undesirable or a nefarious activity.

Without limitation, such an activity includes opening a data tunnel indicative of a data theft or an exfiltration attempt. System 100 is thus able to designate Skype application instance 104C3 as a suspect computer application instance. More generally, it may designate Skype application 104C as a suspect computer application. It is able to identify computer application 104C and specifically its instance 104C3 as Skype by analyzing an application fingerprint or signature contained in the underlying data packets of or related to the application. Depending on the variation, these data packets related to the application may be either generated or consumed by it.

In the preferred embodiment, the application signature or fingerprint is a cryptographic signature. Preferably, the cryptographic signature is a JA3 cryptographic hash or fingerprint known in the art. Those skilled in the art will understand that JA3 is an open-source methodology that allows for creating an message-digest algorithm (MD5) hash of specific values found in the secure socket layer (SSL)/transport layer security (TLS) handshake process. JA3S is a similar methodology for calculating the JA3 hash of a server session. JA3 hashes are commonly used as signatures or fingerprints for the identification for various groups or types of computer applications. Thus, Facebook®, Skype™, LinkedIn®, Youtube™, Quickbooks® all have respective JA3 hashes from which any data packets generated/consumed by them can be identified as such.

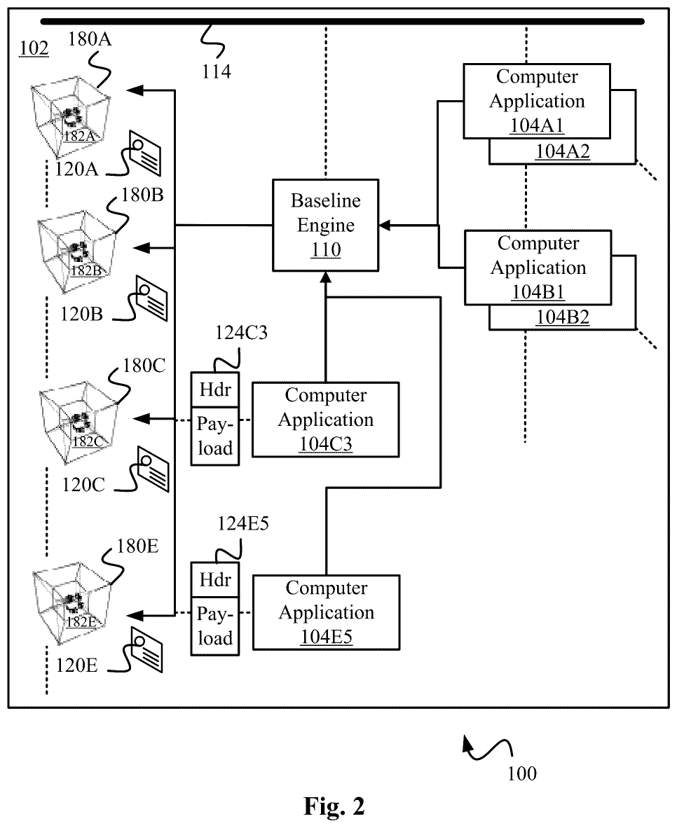

FIG. 2 shows a variation of FIG. 1 where our suspect application identification system 100 has designated two computer applications, and more specifically two specific computer application instances 104C3 and 104E5 as suspect. It has done so because baseline engine 110 found data packets 124C3 AND 124E5 with their headers and payloads as shown, generated respectively by computer application instances 104C3 and 104E5 as suspect or anomalous. This is because data packets 124C3 and 124E5 are far enough away from respective centroids 182C and 182E of respective baselines 120C and 120E representative of normal population of data packets for computer application types/groups 104C and 104E.

Computer system 100 is able to establish the identity of computer application instances 104C3 and 104E5 as of a specific computer application type or group i.e. 104C and 104E. Exemplarily, applications 104C may be Youtube or Netflix, or Facebook, or any other type of applications. Exemplarily, applications 104E may be Microsoft Office 365™ or Intuit Quickbooks Online or LinkedIn or Skype, among others. The identity of computer applications 104 is determined by observing and/or analyzing their application footprint or signature per above. Preferably, the signature is a cryptographic hash, such as a JA3 hash. Preferably still, it is based on the related active fingerprinting technology of JARM.

The suspect application e.g. 104C3 may be doing something undesirable or nefarious on computer network 114. Such an undesirable activity may be opening a network tunnel for stealing data, such as credit card numbers, blueprints, personally identifiable information (PII) data, and any other sensitive data. The activity may also be downloading a movie during business hours, or any other type of unwanted activity on network 114, without limitation.

Alternatively or in addition, the suspect application e.g. 104E5 may be just an outdated version of a legitimate application. For example, hypercube 180E with centroid 182E may represent an older version of Skype that should be updated. Baseline engine 110 designates such an older instance 104E5 as suspect because its data packets score far enough away from centroid 182E representing the data packets of the current version of Skype. Application instance 104E5 designated as suspect above may otherwise be legitimate and not involved in an undesirable/nefarious activity.

However, its designation as suspect and its identification allows security/system administrators to notify the associated user of the older Skype instance 104E5 and similarly any other users of older Skype versions, to upgrade their application. Thus, as a benefit of the present technology, this eases the task of system administration by enforcing standardization of versions of computer applications 104 on network 114.

Still alternatively or in addition, the suspect application e.g. 104C3 may be a malware that is trying to masquerade or impersonate as a legitimate application. In other words, a malware may try to forge the signature, e.g. a JA3 hash of a real computer application e.g. MS Office 365 in order to appear legitimate on computer network 114. System 100 of the present technology is able to designate such a malware as a suspect computer application instance 104C3 that is trying to identify itself as an Office 365 instance. Such masquerading attacks are a constant threat to sysadmins and security admins. The present technology is thus able to uncover such attacks, and the system and security administrators can then take remedial actions.

As explained, suspect application identification system 100 identifies suspect/anomalous computer applications 104 that are associated with anomalous packets of data. Once again, for even a more detailed explanation of the workings of baseline engine 110 of system 100, that is responsible for establishing rolling baselines 120 and then identifying suspect or anomalous data packets, the reader is referred to the above-incorporated references including U.S. Pat. No. 10,542,026 issued on 21 Jan. 2020 to Christian.

System 100 of FIG. 1-2 is also able to detect various indicators of compromise in computer applications 104 and the system(s)/device(s) that they operate on as well as network 114. This is accomplished by utilizing the teachings of above-incorporated reference of U.S. patent application Ser. No. 17/880,898 filed on Aug. 4, 2022. In summary, the indicators of compromise are detected based on rolling baselines 120 by baseline engine 110. The indicators of compromise may manifest themselves in a variety of ways including the exemplary behaviors of the suspect computer application instances 104C3 and 104E5 discussed above.

Without limitation, the indicators of compromise thus detected may also manifest themselves as unintelligible or obfuscated data, unintentionally encrypted data, misreported data by computer applications 104 and their associated systems/devices. The data thus misreported may be underreported or overreported depending on the variation. Exemplarily, the underreporting may occur if an application 104 and/or the device(s)/computer(s)/network that it is operating on, has been intruded by a malware or a hacker. The malware or hacker may now be executing unauthorized remote commands on it and/or is sending/receiving unauthorized messages to/from it on network 114. This overuse of resources may cause the application/device to underreport its data.

The manifestation may also occur as overuse/overage or underuse/underage of a variety of metrics and resources of the application. These include CPU usage, memory usage, disk storage usage, network usage, thermal output, among others. Instant suspect application identification system detects indicators of compromise that may signify a pattern of failure of the application 104 and its associated system(s)/device(s). An early knowledge of the indicators of compromise in the present embodiments allows a concerned party to take immediate remedial actions, so that more devastating downstream consequences can be avoided.

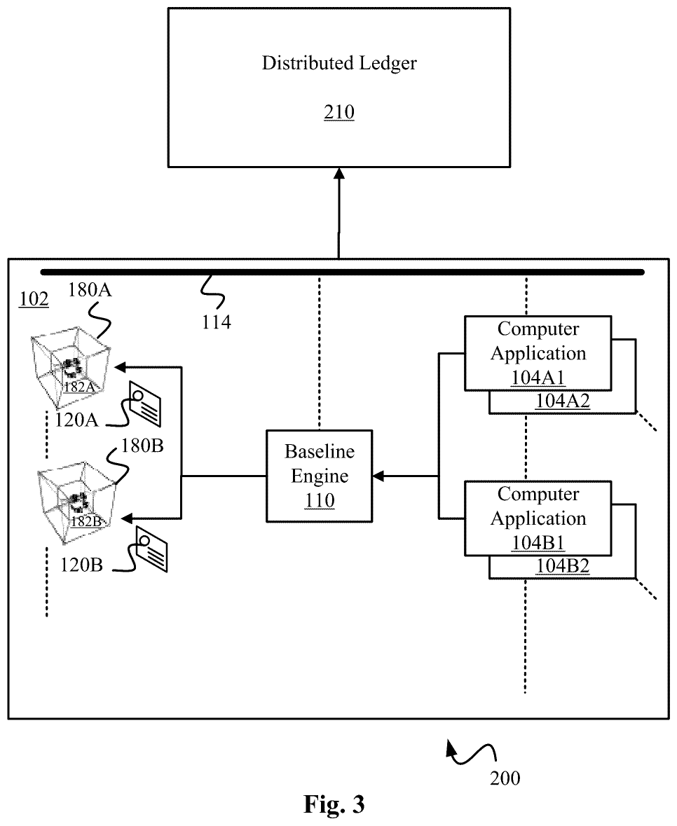

Now let us understand another set of highly preferred embodiments by taking advantage of FIG. 3. FIG. 3 shows a suspect/anomalous computer application identification system 200 of the present technology. Unlike prior embodiments, system 200 records the identity of any suspect computer application instance and any associated data related to the suspect incident/event which caused the instance to be designated as suspect, in a distributed ledger 210. The present embodiments therefore accrue the benefits distributed ledger technology (DLT). Per above, the data associated with or related to the suspect event is referred to as suspect event data.

Those familiar with the art will understand that DLT is a decentralized infrastructure of protocols and systems for the consensus of replicated, shared, and synchronized digital data that is geographically spread (distributed) across many sites, countries, or institutions. In contrast to a centralized database, a distributed ledger does not have a central data store and does require a central administrator, and consequently does not have a single point-of-failure.

Distributed ledger data is spread across multiple nodes (computational devices) on a P2P network, where each node replicates and saves an identical copy of the ledger data and updates itself independently of other nodes. The present embodiments thus record the suspect or anomalous data and its attributes, along with the identities of associated suspect applications/instances in distributed ledger 210 of FIG. 3.

By taking advantage of recording suspect/anomalous event and associated application data i.e. suspect event data as well as any other desired data fields/attributes in distributed ledger 210, the present embodiments can derive a number useful insights about the suspect event and application. Such insights allow system and security admins to take appropriate remedial and often proactive actions against offending or potentially offending users or applications. For instance, the security admins may prevent offending or potentially offending users and/or applications or instances from accessing certain networks or network segments.

Any desired set of attributes associated with the event or transaction may be recorded in the distributed ledger. These attributes include but are not limited to a username for a user of the suspect computer application, a username for the user who generated the data, a username for the user who transmitted the data, a name of a network protocol used in a transmission of the data, a device name, an Internet Protocol (IP) address, a machine name, a Media Access Control (MAC) address, a Network Interface Card (NIC) address, a port number on which the transmission was made, and any other attributes of interest.

Given the DLT technology, once a block containing suspect event data has been recorded, it is immutable. This allows for a variety of downstream historical analyses to per formed on the recorded data. Such analyses are then used to derive useful security insights about the suspect events and the applications/users in questions. Without limitation, such insights include predicting patterns of failure of various computer applications, predicting patterns of threats, their severity and timings, as well as identifying certain types or categories of applications, devices and users that are more prone to or associated with security incidents.

The above is accomplished by analyzing a failure rate or frequency of suspect events, their types, categories, timings and relationship to various types of computer applications 104. For example, a certain video streaming application may be more vulnerable to data exfiltration threats/events while a certain social-networking application may be most associated with phishing events.

In the preferred variation of the present embodiments, the distributed ledger is implemented using the Blockchain technology. Blockchain is a distributed ledger with an ever-growing list of blocks or records that are securely linked together via cryptographic hashes. Each block is identified by its cryptographic hash or block header hash or simply block hash. Each block also contains the hash of the previous block, as well as a date/timestamp and transaction data. The transaction data is generally represented as a Merkle tree, where data nodes are represented by leaves. In the present design, the transaction data would comprise the suspect event data.

The date/timestamp or simply timestamp proves that the transaction data existed when the block was created. Since each block contains information about the previous block, they effectively form a chain, with each additional block linking to the previous block. As a result, blockchain transactions are immutable or irreversible in that, once they are recorded, the data in any given block cannot be altered retroactively without altering all subsequent blocks.

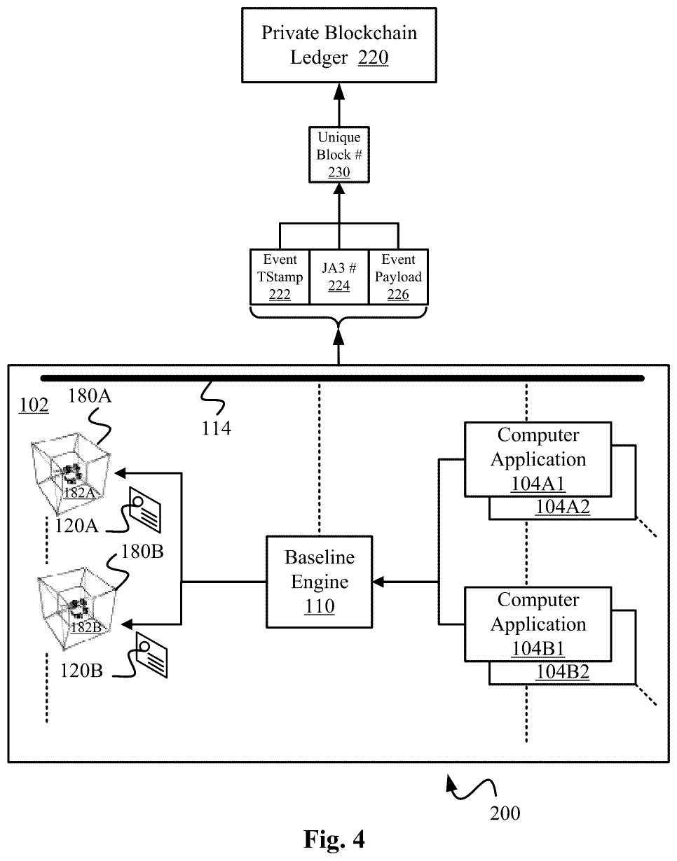

FIG. 4 shows the details of a variation of FIG. 3 where the distributed ledger is a Blockchain ledger. More specifically, in FIG. 4, the distributed ledger is a private or internal blockchain ledger 220. Any suspect or anomalous event discovered by our suspect application identification system 200 is recorded as a block in private blockchain 220. This is accomplished by generating a unique block hash or a unique event payload hash or a unique event hash or just simply a block hash 230. Block hash 230 is evidently unique per block and is in turn derived from various data attributes related to the suspect security incident or the suspect event and the associated suspect computer application and/or its instance. These data attributes include but are not limited to those shown in FIG. 4.

More specifically, the data attributes or fields used to derive block hash 230 include a date/time stamp 220 of the suspect event. The attributes/fields also include the cryptographic hash such as a JA3 hash/#224 that identifies the computer application type whose instance caused the suspect event. The attributes/fields also include a portion or all of the payload 226 of the suspect event data associated with the suspect event. Hash 230 is derived using a suitable hash/key derivation function known in the art.

As a way of an example, a suspect event can be a connection initiated by a suspect instance of Skype as identified by its JA3#. The payload may be an MS Office file, e.g. a .doc or .docx file signifying a data theft/or exfiltration attempt by the suspect instance of Skype. In the above example, the connection was a network or Transport Control Protocol/Internet Protocol (TCP/IP) connection. Thus, data attribute 222 in FIG. 4 is the data/timestamp at which the TCP/IP connection was opened, attribute 224 is the JA3# for Skype and attribute 226 is the some or all of the data file that was attempted to be transferred.

Unique block hash 230 derived from the above attributes is then used to identify the new block that is then added to blockchain 220. Any other desired event or transaction data attributes may also be recorded in the block. These include but are not limited to username, group privilege(s), user privilege(s), IP address, unique identifier of the machine/device such as MAC address and/or an IP address and/or processor ID and/or any unique attribute of that event that could differentiate it or designate/identify it based on its unique properties.

In another example, the event may just be a Universal Serial Bus (USB) connection whereby a suspect application instance e.g. Youtube tries to copy/exfiltrate data to an external USB drive. In this case, data attribute 222 in FIG. 4 is the data/timestamp at which the USB connection was opened, attribute 224 is the JA3# for Youtube and attribute 226 is some or all of the data file that was attempted to be copied. Unique block hash 230 derived from the above attributes is then used to identify the new block that is then added to blockchain 220. Any other desired transaction data may also be recorded in the block.

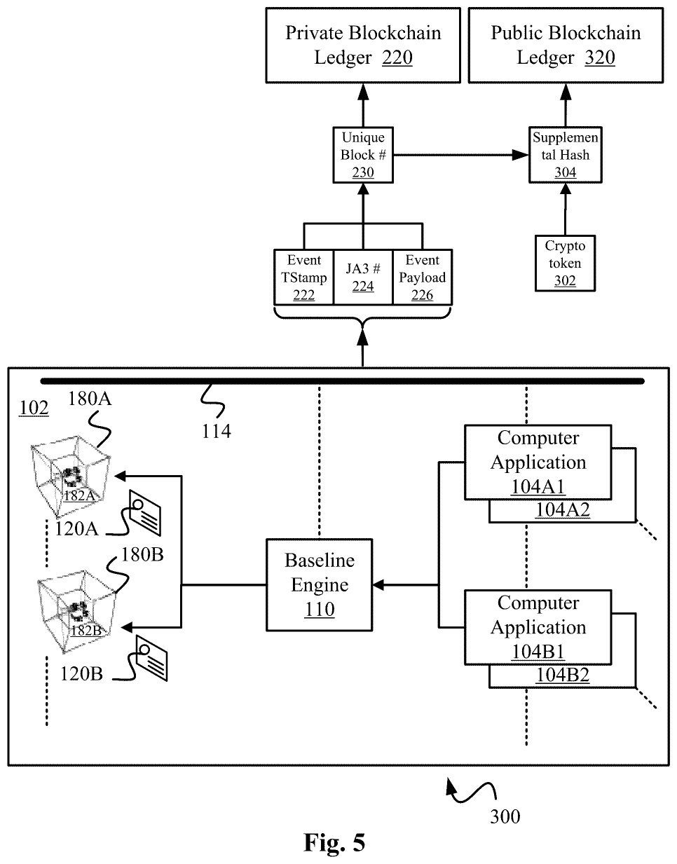

Now let us take a look at the variation shown in FIG. 5 of the present embodiments. In suspect/anomalous application identification system 300 of FIG. 3, the internal or private blockchain ledger 220 of the prior embodiments is also linked to a public blockchain ledger 320. This linkage is accomplished by way of a supplemental hash that is derived from the unique block hash 230 explained above, as well as a crypto token 302 associated with public ledger 320. Let us know understand this variation in greater detail by way of some practical examples.

Crypto tokens 302 may be those of one of the many available cryptocurrency tokens. These include but are not limited to Bitcoin, Ethereum, Dogecoin, and the like. After a new suspect or anomalous event is observed/discovered and recorded in private ledger 220 by system 300 per above teachings, it is then also recorded in a public blockchain ledger such as those associated with the above-mentioned cryptocurrencies. For example, if public ledger 320 is the Bitcoin ledger, then a Bitcoin token is first obtained. This is done by purchasing 1 Bitcoin or using 1 Bitcoin from a pool of available Bitcoins.

Then, block hash of the Bitcoin just obtained is combined with block hash 230 of internal ledger 220 of the above teachings, to obtain a supplemental hash 304. This supplemental hash is the unique block hash for the public Bitcoin ledger 320. A new block with block hash 304 is then inserted into Bitcoin ledger 320 along with any other associated event or transaction data of interest. Supplemental hash or block hash 304 is derived using a suitable hash/key derivation function known in the art. The process is analogous with any other type of crypto tokens.

For example, in order to insert a block associated with our suspect event in the Ethereum public ledger, block hash 230 is combined with the block hash of an Ethereum token to derive or obtain supplemental hash 304. This supplemental hash 304 is then used to record the suspect event data in the Ethereum public ledger 320, along with any other transaction/event data of interest per above teachings.

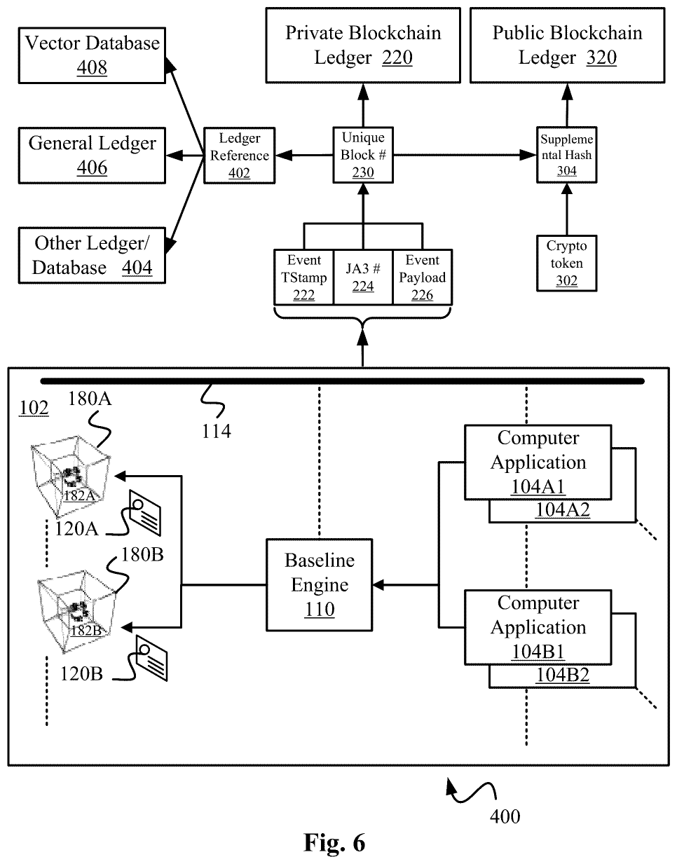

In an alternative or related variation 400 of the above suspect application identification shown in FIG. 6, private blockchain ledger 220 is linked to another computer system or application. Such a computer system or application may be external to environment 102 or internal to it, and may not be a distributed ledger. This linkage is accomplished by deriving a ledger reference 402 from block hash 230 of the above teachings. In the simplest implementation, ledger reference 402 is the same as block hash 230.

Ledger reference 402 is then used as a unique key to record the suspect event of the above teachings in another system or computer application. As mentioned, such a computer system or application may be external to environment 102 or internal to it. Such a computer system may be at a partner premises or in the cloud. Such a system/application may be a traditional database or ledger 404. Examples of a traditional database is a relational database e.g. Oracle, MySQL®, among others. Instead of or in addition, the system that private ledger 220 links to may also be a traditional general ledger 406 known in the art e.g. Quickbooks, Netsuite.

Instead of or in addition, the application that private ledger 220 links to may also be a vector database 408 e.g. Pinecone™, Chroma™, among others. Instead of or in addition, the system/application that private blockchain ledger 220 links to may be any other computer applications e.g. an enterprise resource planning (ERP) system and the linking happens by utilizing an appropriate application programming interface (API) call of such an ERP system.

Still alternatively or in addition, system 400 may also have its own API published, that is used by one or more of the above systems/applications to record a suspect event observed by system 400 along with the associated application identity and any other desired data. Per above, suspect application identification system 400 discovers such anomalous or suspect events by utilizing baseline engine 110 and baselines 120 with associated hypercubes 180 and centroids 182.

In view of the above teaching, a person skilled in the art will recognize that the apparatus and method of invention can be embodied in many different ways in addition to those described without departing from the principles of the invention. Therefore, the scope of the invention should be judged in view of the appended claims and their legal equivalents.

What is claimed is:

1. A system comprising computer-readable instructions stored in a non-transitory storage medium and at least one microprocessor coupled to said non-transitory storage medium for executing said computer-readable instructions, said at least one microprocessor configured to:
(a) analyze data on a computer network, said data related to a computer application;
(b) establish a rolling baseline of said data by assigning each packet of said data to a cluster of packets amongst a plurality of clusters of packets of said data;
(c) score, based on its distance from a centroid of said rolling baseline, each packet of said data;
(d) determine an identity of said computer application based on a cryptographic signature; and
(e) designate based on said distance, an instance of said computer application as a suspect computer application instance.

2. The system of claim 1, wherein said cryptographic signature is a JA3 hash.

3. The system of claim 1, wherein said suspect computer application instance masquerades said identity by forging said cryptographic signature.

4. The system of claim 1, wherein said identity is one of a video-streaming application, an audio-streaming application, a social-networking application, a business application, a document management application, an artificial intelligence (AI) application, a computer-aided design (CAD) application, a graphics program application, an integrated development environment (IDE) application, a data science graphing application and a computer gaming application.

5. The system of claim 4, wherein said suspect computer application instance is an outdated version of said computer application.

6. The system of claim 1, wherein said at least one microprocessor is further configured to record said identity and suspect event data related to said suspect computer application instance in a block of a distributed ledger.

7. The system of claim 6, wherein said at least one microprocessor is further configured to analyze said suspect event data and produce insights about said computer application.

8. The system of claim 6, wherein said distributed ledger is a blockchain ledger.

9. The system of claim 8, wherein said blockchain ledger is private and said block has a unique hash derived from data fields including a date and time associated with said suspect event data, said cryptographic signature and a portion or all of a payload of said suspect event data.

10. The system of claim 9, wherein said blockchain ledger links via a ledger reference data field to one or more of a vector database, a general ledger, a relational database and a partner computer application.

11. The system of claim 8, wherein said private blockchain ledger links to a public blockchain ledger by a supplemental hash.

12. The system of claim 11, wherein said public blockchain ledger is one or more of a Bitcoin blockchain, an Ethereum blockchain and a Dogecoin blockchain.

13. A computer-implemented method executing computer-readable instructions by at least one processor, said computer-readable instructions stored in a non-transitory storage medium coupled to said at least one processor, and said computer-implemented method comprising the steps of:
(a) analyzing data related to a computer application operating on a computer network;
(b) establishing a rolling baseline of said data by assigning each packet of said data to a cluster of packets amongst a plurality of clusters of packets of said data;
(c) scoring, based on its distance from a centroid of said rolling baseline, each packet of said data;
(d) determining an identity of said computer application based on a cryptographic signature; and
(e) designating based on said distance, an instance of said computer application as a suspect computer application instance.

14. The method of claim 13 providing said cryptographic signature to be a JA3 hash.

15. The method of claim 13 with said suspect computer application instance masquerading said identity by forging said cryptographic signature.

16. The method of claim 13 with said suspect computer application instance being an outdated version of said computer application.

17. The method of claim 13 recording said identity and suspect event data related to said suspect computer application instance in a block of a private blockchain ledger.

18. The method of claim 17 performing said recording in said block with a unique block hash, and deriving said unique block hash from data fields including a date and time associated with said suspect event data, said cryptographic signature and a portion or all of a payload of said suspect event data.

19. The method of claim 17 linking said blockchain ledger via a ledger reference data field to one of a partner computer application, a vector database, a general ledger and a relational database.

20. The method of claim 17 linking said blockchain ledger via a supplemental hash to a public blockchain ledger.
